(19) United States
(12) Patent Application Publication
(10) Pub. No.: US 2014/0232218 A1
(43) Pub. Date: Aug. 21, 2014

(54) COOLING SYSTEM AND COOLING METHOD FOR COOLING ROTATING ELECTRICAL MACHINE

(71) Applicant: FANUC CORPORATION, Yamanashi (JP)

(72) Inventors: Shinobu Takano, Yamanashi (JP); Yohei Arimatsu, Yamanashi (JP)

(73) Assignee: FANUC CORPORATION, Yamanashi (JP)

(21) Appl. No.: 14/174,313

(22) Filed: Feb. 6, 2014

(30) Foreign Application Priority Data
Feb. 15, 2013 (JP) 2013-028070

(51) Int. Cl. H02K 9/19

(52) U.S. Cl. CPC H02K 9/19
USPC 310/53

(57) ABSTRACT

A cooling system and a cooling method, capable of reducing a temperature gradient of a rotating electrical machine by means of a simple structure, in relation to both axial and circumferential directions thereof. The cooling system has a coolant conveying device such as a pump, and a coolant cooling device such as a heat pump. The conveying device is fluidly communicated with a flow path via a coolant pipe 32, whereby a circulatory coolant path is formed in which coolant conveyed from the pump flows in the path of a jacket and returns to the pump. The coolant conveying device is configured to reverse the flow direction of coolant, whereby the flow direction in the flow path can be properly reversed.

### BACKGROUND OF THE INVENTION

1. Field of the Invention

The present invention relates to a cooling system and a cooling method for cooling a rotating electrical machine by using coolant, in particular, for cooling a stator of the machine.

2. Description of the Related Art

In the prior art, as a countermeasure against generated heat of an electric motor, a structure for flowing coolant into a housing of the motor may be used, and the structure has been variously modified. For example, JP 2011-015578 A discloses a cooling device for an electric motor, wherein a plurality of spiral grooves extending parallel to each other are formed on a jacket fitted to an outside of a stator, for providing coolant flow paths.

JP H11-033877 A discloses a cooling system, wherein a plurality of grooves (flow paths) are formed on an inner surface of a cover having the same inner diameter as an outer diameter of a motor housing, so that flow directions of coolant of the neighboring grooves are different from each other.

Further, JP 2000-092815 A discloses a stage device having flow switching valves are arranged, wherein the switching valves are operated by means of an arithmetic and control unit at predetermined intervals so as to reverse a flow direction of coolant which circulates in a linear motor section.

In the cooling device as described in JP 2011-015578 A, a temperature gradient occurs in the electric motor in relation to both the axial and circumferential directions thereof, and the device may have a distortion depending on the magnitude of the temperature gradient. In the structure of JP H11-033877, as shown in FIG. 3 thereof, it is necessary to form two flow paths having different shapes, and provide inlet and outlet ports to each flow path. Therefore, the pipe structure is complicated and cost thereof may be increased.

On the other hand, in the invention of JP 2000-092815, by reversing the flow direction of coolant, the temperature gradient in the linear motor section may be reduced and the positioning accuracy may be prevented being from deteriorated. However, the invention of JP 2000-092815 is not applied to a rotating electrical machine, and is not intended to solve a problem specific to the rotating electrical machine, i.e., reduce the temperature gradient in relation to both the axial and circumferential directions.

### SUMMARY OF THE INVENTION

The object of the present invention is to provide a cooling system and a cooling method, capable of reducing a temperature gradient of a rotating electrical machine by means of a simple structure, in relation to both the axial and circumferential directions thereof.

One aspect of the present invention provides a cooling system for cooling a rotating electrical machine, comprising: a coolant cooling device which cools coolant; a coolant conveying device connected to the coolant cooling device, the coolant conveying device being configured to convey coolant cooled by the coolant cooling device; and a spiral coolant flow path fluidly connected to the coolant conveying device, the coolant flow path being positioned adjacent to an outer circumferential surface of a stator of the rotating electrical machine, wherein the rotating electrical machine has a reversing device which reverses a flow direction of coolant in the flow path based on a predetermined condition.

In a preferred embodiment, the coolant conveying device has a function for reversing the flow direction of the coolant.

In a preferred embodiment, the cooling system comprises a pipe structure including at least one branch point and at least one valve, the branch point and the valve being positioned between the coolant conveying device and an inlet port or an outlet port of the coolant flow path, wherein the flow direction of coolant in the coolant flow path is reversed by operating the valve.

In a preferred embodiment, the cooling system further comprises a command generating part configured to transmit a command or signal to the reversing device in order to reverse the flow direction of coolant in the coolant flow path.

Another aspect of the present invention provides a method for cooling a rotating electrical machine, by using a coolant cooling device which cools coolant; a coolant conveying device configured to convey coolant cooled by the coolant cooling device; and a spiral coolant flow path, in which coolant flows, positioned adjacent to an outer circumferential surface of a stator of the rotating electrical machine, the method comprising the step of: reversing a flow direction of coolant in the flow path based on a predetermined condition.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a view showing a schematic configuration of a cooling system for a rotating electrical machine according to a first embodiment of the invention;

FIG. 2 is a view showing a schematic configuration of a cooling system for a rotating electrical machine according to a second embodiment of the invention;

FIG. 3 is a view showing a schematic configuration of a cooling system for a rotating electrical machine according to a third embodiment of the invention;

FIG. 4 shows an example wherein a command generating part is arranged for reversing a flow direction of coolant;

FIG. 5 shows an example wherein measuring equipment is provided to the configuration of FIG. 4;

FIG. 6 shows an example wherein measuring equipment is arranged in a drive unit of the rotating electrical machine;

FIG. 7 is a view showing a configuration example of a jacket which constitutes a flow path of the cooling system of the invention; and

FIG. 8 is a view showing another configuration example of a jacket which constitutes a flow path of the cooling system of the invention.

### DETAILED DESCRIPTION

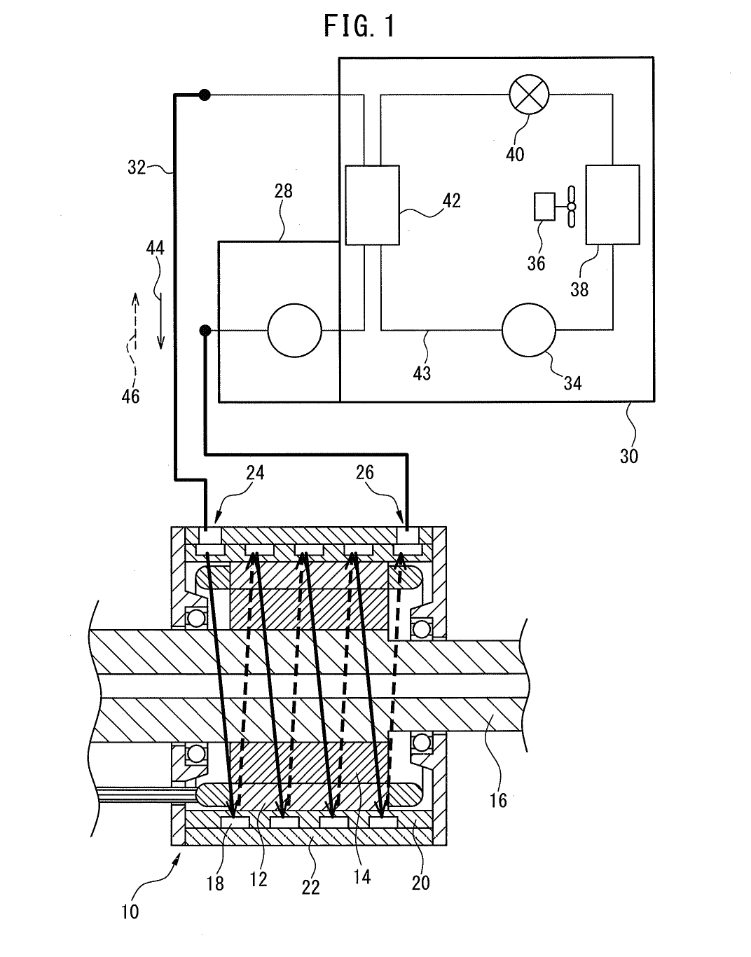

FIG. 1 is a view showing a schematic configuration of a cooling system for a rotating electrical machine according to a first embodiment of the invention. A rotating electrical machine or motor 10, to which the cooling system is applied, has a stator (or armature) 12, a rotor 14 rotatable relative to stator 12, a rotating shaft 16 rotatable integrally with rotor 14, and a jacket 20 (see FIG. 7 as described below) on which a coolant flow path 18 is formed so that coolant for cooling rotating electrical machine 10 (in particular, stator 12) flows in the flow path. In this embodiment, jacket 20 is positioned adjacent to an outer circumferential surface of stator 12. Flow path 18 of jacket 20 is defined by a spiral groove formed on an outer circumferential surface of jacket 20 and an inner circumferential surface of a housing or sleeve 22 which surrounds jacket 20, wherein the length of the spiral groove is equal to or more than one lap of the circumference of jacket 20. Sleeve 22 has at least two openings 24 and 26 fluidly connected to flow path 18, and a pipe for coolant is connected to each opening as described below.

As shown in FIG. 1, the cooling system of the invention has a coolant conveying device 28 such as a pump, and a coolant cooling device 30 such as a heat pump. Conveying device 28 is fluidly communicated with flow path 18 (concretely, openings 24 and 26 of sleeve 22) via a coolant pipe 32, whereby a circulatory coolant path is formed in which coolant conveyed from pump 28 flows in path 18 of jacket 20 and returns to pump 28. On the other hand, cooling device 30 may be any device capable of cooling coolant which flows in coolant pipe 32. For example, cooling device 30 may be a heat pump having a compressor 34, a condenser 36 with a fan 36, an expansion valve 40, a cooler or heat exchanger 42, and a pipe 43 which fluidly circularly connects compressor 34, condenser 36, expansion valve 40 and cooler 42.

In the first embodiment, coolant conveying device 28 such as a pump is configured to reverse the flow direction of coolant, whereby the flow direction in coolant pipe 32 can be selectively changed (or reversed), as indicated by arrows 44 and 36. As a result, the flow direction of coolant in flow path 18 can also be reversed.

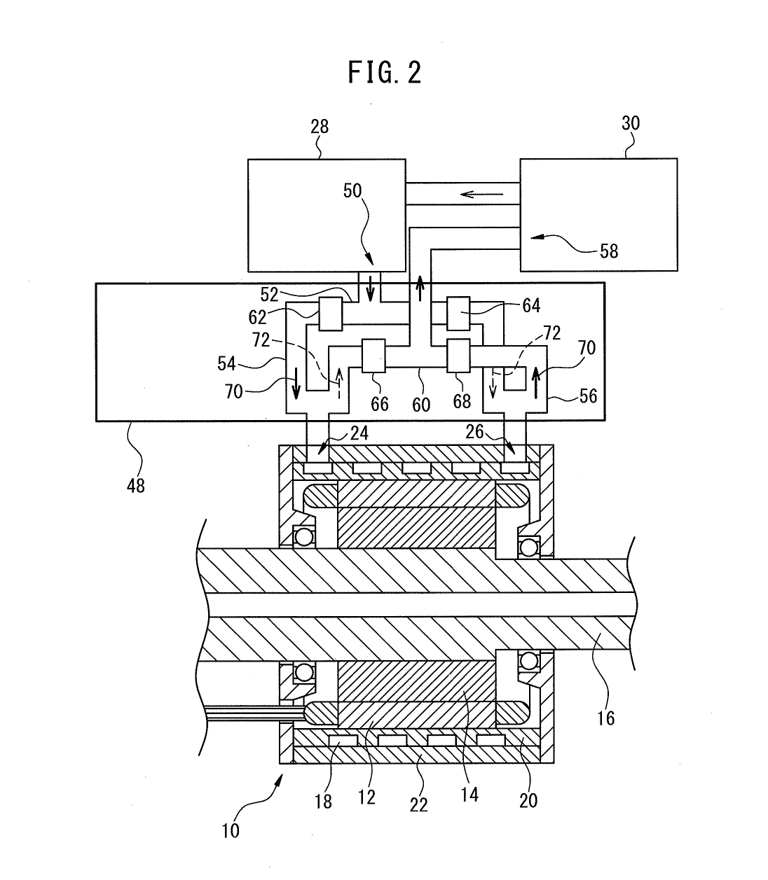

FIG. 2 is a view showing a schematic configuration of a cooling system for a rotating electrical machine according to a second embodiment of the invention. The second embodiment is different from the first embodiment in that the coolant conveying device 28 such as a pump does not have a function for reversing the flow direction of coolant, instead, a coolant reversing device 48 for reversing the flow direction of coolant is provided. Since rotating electrical machine 10 of the second embodiment may be the same as the first embodiment, the same reference numerals are added to the corresponding components and a detailed explanation thereof will be omitted.

In the second embodiment, reversing device 48 has a pipe structure which reverses the flow direction of coolant in flow path 18 by switching an on-off valve. Concretely, as shown in FIG. 2, the pipe structure includes a first branch point or pipe 52 which diverges from an outlet 50 of conveying device 28 in two directions, a second branch point or pipe 54 which diverges from one opening 24 of sleeve 22 in two directions, a third branch point or pipe 56 which diverges from another opening 26 of sleeve 22 in two directions, and a fourth branch point or pipe 60 which diverges from an inlet 58 of cooling device 30 in two directions. The pipe structure further includes a first valve 62 which connects one end of first branch pipe 52 and one end of second branch pipe 54, a second valve 64 which connects the other end of first branch pipe 52 and one end of third branch pipe 56, a third valve 66 which connects the other end of second branch pipe 54 and one end of fourth branch pipe 60, and a fourth valve 68 which connects the other end of third branch pipe 56 and the other end of fourth branch pipe 60.

When coolant should flow in a positive direction as indicated by an arrow 70, first valve 62 and fourth valve 68 are opened, and second valve 64 and third valve 66 are closed. On the other hand, when coolant should flow in a negative direction as indicated by an arrow 72, first valve 62 and fourth valve 68 are closed, and second valve 64 and third valve 66 are opened. As such, in the second embodiment, although conveying device 28 does not has the function for reversing the flow direction of coolant, the flow direction can be easily reversed by the switching operation of the valve. In addition, the switching operation of the valve may be carried out manually or automatically based on a predetermined condition.

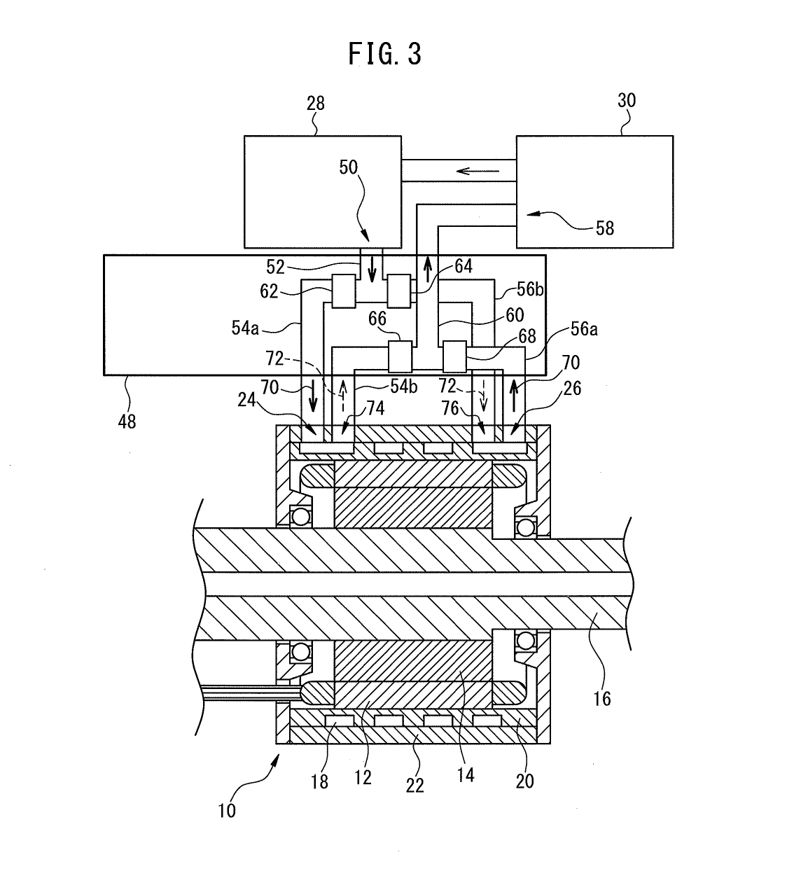

FIG. 3 is a view showing a schematic configuration of a cooling system for a rotating electrical machine according to a third embodiment of the invention. The third embodiment is different from the second embodiment in the structures of second and third branch pipes, and the number of openings of the sleeve. Therefore, in the third embodiment, the same reference numerals are added to the corresponding components and a detailed explanation thereof will be omitted.

In the third embodiment, a pipe corresponding to second branch pipe 54 in the second embodiment is not a branch pipe. Concretely, a pipe 54a which connects first valve 62 and opening 24 of sleeve 22, and a pipe 54b which connects third valve 66 and a newly formed opening 74 of sleeve 22, are arranged. Similarly, a pipe corresponding to third branch pipe 56, concretely, a pipe 56a which connects fourth valve 68 and opening 26 of sleeve 22, and a pipe 56b which connects second valve 64 and a newly formed opening 76 of sleeve 22, are arranged. It is preferable that openings 74 and 76 be adjacent to openings 24 and 26, respectively. In the third embodiment, by the valve operation similar to the second embodiment, the flow direction of coolant can be switched between the positive direction as indicated by arrow 70 and a negative direction as indicated by arrow 72.

According to the present invention, the temperature gradient may be reduced and the temperature of the rotating electrical machine may be homogenized in relation to both the axial direction and the circumferential directions thereof. Therefore, the rotating electrical machine is prevented from being deformed due to the difference in amounts of thermal expansion, whereby the deterioration of rotation accuracy of the machine can be avoided. Although a switching period of time of the flow direction may be properly determined depending on desired performance of the rotating electric motor (e.g., an allowable temperature difference within the rotating motor), the temperature gradient is decreased as the switching period of time gets shorter. In addition, although the coolant conveying device, the coolant cooling device and coolant reversing device are illustrated as separate devices in the above embodiments, these devices may be constituted as an integrated unit.

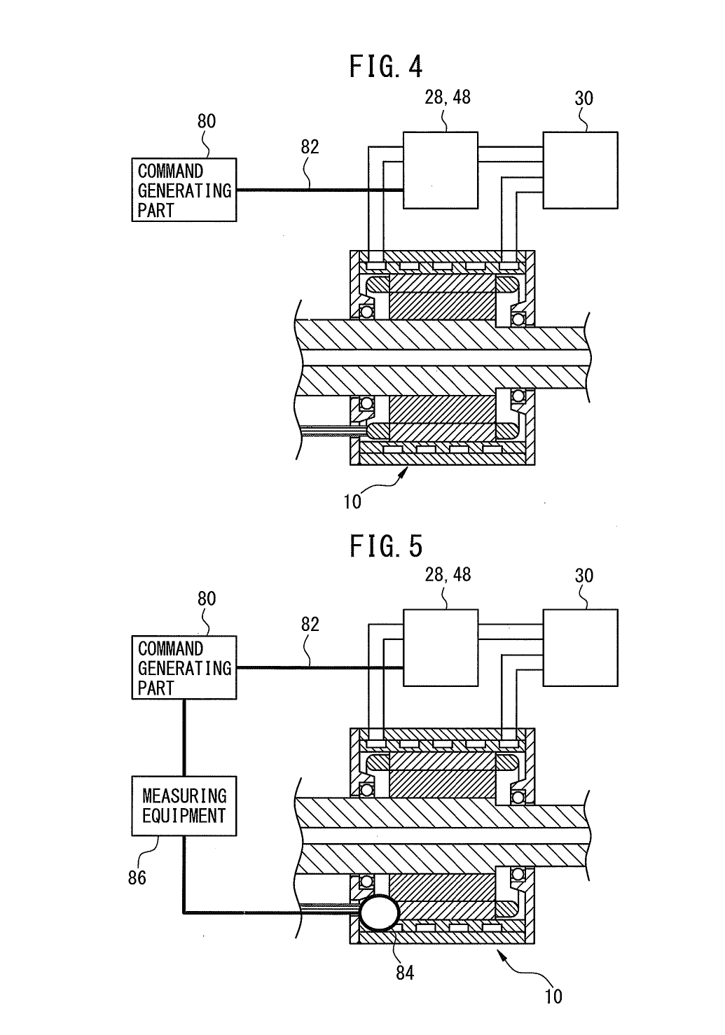

FIGS. 4 to 6 show an example wherein a timing of reversing the flow direction of coolant is controlled by a command generating part in the cooling system of the invention. A command generating part 80 has at least one of: a first function for setting a set value for determining a timing of reversing the flow direction of coolant, and outputting a command or signal for reversing the flow direction based on the set value; and a second function for receiving a signal for determining the timing of reversing from another unit, etc., and outputting a command or signal for reversing the flow direction.

FIG. 4 shows a configuration example wherein command generating part 80 has the first function described above. Command generating part 80 is connected, via a signal line 82, to coolant conveying device 28 in the first embodiment or coolant reversing device 48 in the second or third embodiment, whereby command generating part 80 can transmit a command or signal for reversing the flow direction of coolant to conveying device 28 or reversing device 48. As an example of the setting value for determining the timing of reversing the flow direction, the flow direction may be reversed each time when a predetermined setting time such as thirty seconds or one minute has been passed, otherwise, the flow direction may be reversed at given times. In addition, command generating part 80 may have a timer or clock therefor.

FIG. 5 shows a configuration example wherein command generating part 80 has the second function described above. Similarly to FIG. 4, command generating part 80 is connected, via a signal line 82, to coolant conveying device 28 in the first embodiment or coolant reversing device 48 in the second or third embodiment, whereby command generating part 80 can transmit a command or signal for reversing the flow direction of coolant to conveying device 28 or reversing device 48. In FIG. 5, there are further provided a sensor 84 for measuring physical data of the rotating electrical machine (in this case, the temperature of a winding wire of the machine), and a measurement equipment 86 for transmitting a measurement result of sensor 84, in a form of a signal, etc., to command generating part 80. In the example of FIG. 5, the flow direction of coolant may be reversed when the temperature of the winding wire reaches a predetermined temperature (for example, 60 degrees C.).

Otherwise, when sensor 84 is a strain sensor, a change in dimension of rotating machine 10 may be measured. Then, when the change in dimension exceeds a predetermined allowable value (for example, a distance between openings 24 and 26 of sleeve 22 is changed by ten micrometers), the flow direction of coolant may be reversed. In addition, although measurement equipment 86 is illustrated as a separate unit from command generating part 80, measurement equipment 86 may be incorporated into command generating part 80, coolant conveying device 28, or coolant reversing device 48.

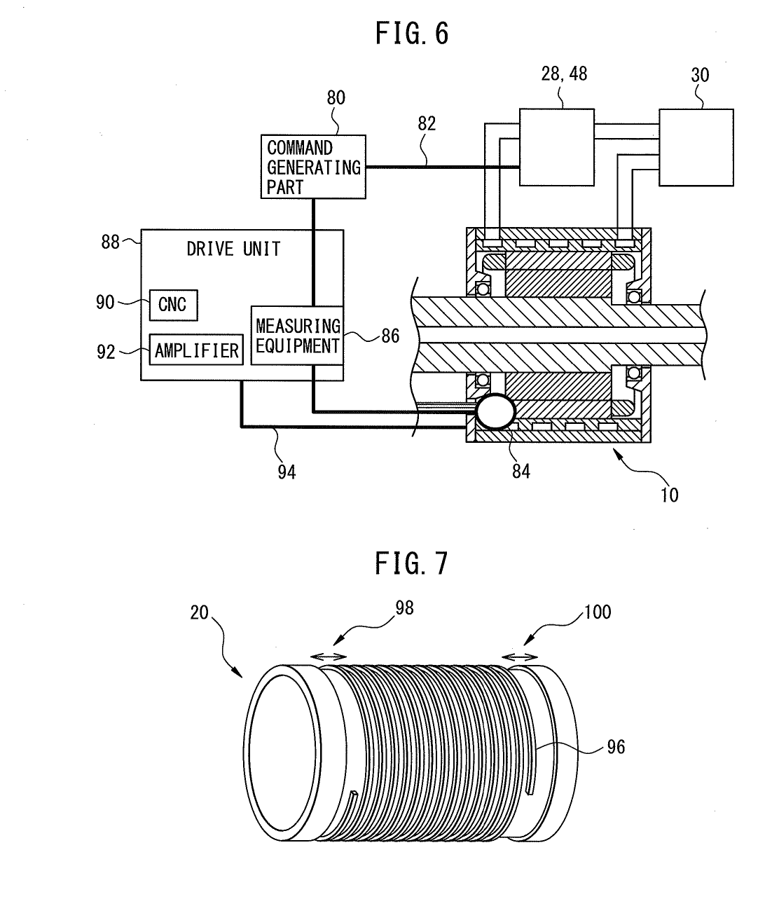

FIG. 6 shows an example wherein measuring equipment 86 is arranged in a drive unit 88 of rotating electrical machine 10. Drive unit 88 has a CNC device 90 and an amplifier 92. Drive unit 88 is connected to rotating electrical machine 10 via a cable 94 so as to control rotating machine 10, and is configured to receive information such as a load or current of rotating machine 10. In the example of FIG. 6, a state of rotating electrical machine (for example, a rotating speed, the temperature of the winding wire, the temperature of a power cable, a load and/or a current value) may be monitored, and the flow direction of coolant may be flexibly and properly reversed based on the state. For example, a cycle of reversing the flow direction may be increased at a low load operation, and the cycle of reversing may be increased at a high load operation. Further, when the temperature of the winding wire reaches a predetermined temperature, the flow direction may be forcibly reversed even when the above timing has not come. In addition, also in the example of FIG. 6, measurement equipment 86 may be incorporated into command generating part 80, coolant conveying device 28, or coolant reversing device 48.

FIG. 7 is a view showing a configuration example of jacket 20 for constituting spiral coolant flow path 18 in the above embodiment. As shown, jacket 20 is a generally cylindrical member, and has a spiral groove formed by a ridge (or screw thread) 96 spirally extending on an outer circumferential surface of the member. As explained with reference to FIG. 1, spiral coolant flow path 18 is formed by the spiral groove and the inner circumferential surface of sleeve 22 fitted with jacket 20. Further, openings 24 and 26 of sleeve 22 as described above are formed at the positions corresponding to positions of both axial ends ridge 96, as indicated by arrows 98 and 100. By properly reversing the flow direction of coolant which flows in such a flow path, the temperature gradient can be eliminated or reduced in relation to both the axial and circumferential directions of the rotating electrical machine.

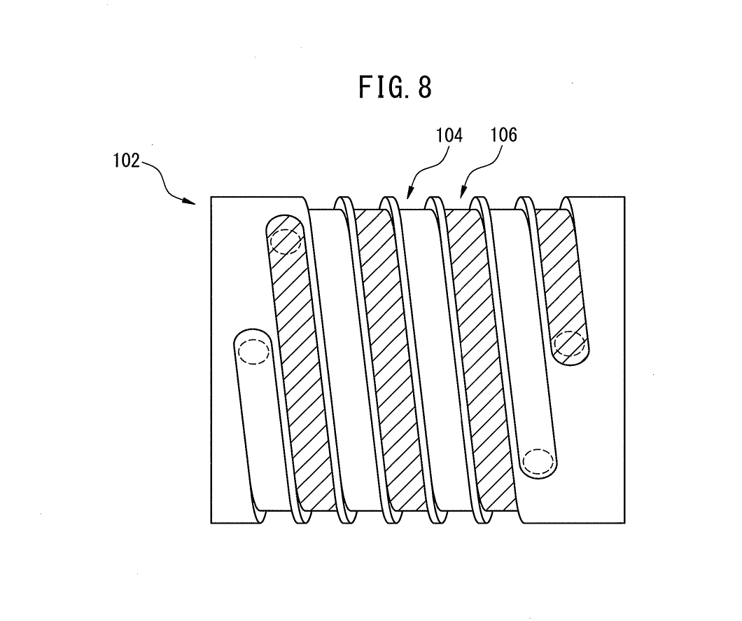

FIG. 8 is a view showing another configuration example of a jacket for constituting a spiral coolant flow path. Jacket 102 shown in FIG. 8 is a generally cylindrical member having a multiple-thread structure, wherein the flow path is substantially divided into separate paths depending on the number of threads. In the example of FIG. 8, jacket 102 has a double-thread structure, concretely, has two spiral grooves 104 and 106 which are separated by a ridge (in the drawing, groove 106 is hatched). Two spiral coolant flow paths are formed by grooves 104 and 106 jacket 102 and a sleeve (not shown) fitted with jacket 102. In addition, since each flow path must have inlet and outlet ports for coolant, openings are formed on the sleeve fitted with jacket 102, corresponding to positions of the inlet and outlet ports of each flow path. In the example of FIG. 8, four openings are formed as indicated by dashed lines.

When the multiple-thread structure as shown in FIG. 8 is used, the flow directions of neighboring coolant flow paths may be opposite each other. However, in such a case, coolant may be mixed between neighboring flow paths, depending on a gap or clearance between the jacket and the sleeve, whereby cooling efficiency of the system may be deteriorated. The present invention can be properly applied to such a multiple-thread structure.

According to the present invention, the flow direction of coolant which flows in the spiral coolant flow path formed on the outer circumferential surface of the stator can be properly reversed. Therefore, the temperature gradient can be eliminated or reduced in relation to both the axial and circumferential directions of the rotating electrical machine, whereby change in dimension and reduction of accuracy caused by heat can be avoided. Further, since the present invention can be applied to a conventional rotating electrical machine having a spiral coolant flow path, a rotating electrical machine with high performance can be provided at low cost.

While the invention has been described with reference to specific embodiments chosen for the purpose of illustration, it should be apparent that numerous modifications could be made thereto, by a person skilled in the art, without departing from the basic concept and scope of the invention.

1. A cooling system for cooling a rotating electrical machine, comprising:
a coolant cooling device which cools coolant;
a coolant conveying device connected to the coolant cooling device, the coolant conveying device being configured to convey coolant cooled by the coolant cooling device; and
a spiral coolant flow path fluidly connected to the coolant conveying device, the coolant flow path being positioned adjacent to an outer circumferential surface of a stator of the rotating electrical machine,
wherein the rotating electrical machine has a reversing device which reverses a flow direction of coolant in the flow path based on a predetermined condition.

2. The cooling system as set forth in claim 1, wherein the coolant conveying device has a function for reversing the flow direction of the coolant.

3. The cooling system as set forth in claim 1, comprising a pipe structure including at least one branch point and at least one valve, the branch point and the valve being positioned between the coolant conveying device and an inlet port or an outlet port of the coolant flow path,
wherein the flow direction of coolant in the coolant flow path is reversed by operating the valve.

4. The cooling system as set forth in claim 1, further comprising a command generating part configured to transmit a command or signal to the reversing device in order to reverse the flow direction of coolant in the coolant flow path.

5. A method for cooling a rotating electrical machine, by using a coolant cooling device which cools coolant; a coolant conveying device configured to convey coolant cooled by the coolant cooling device; and a spiral coolant flow path, in which coolant flows, positioned adjacent to an outer circumferential surface of a stator of the rotating electrical machine, the method comprising the step of:
reversing a flow direction of coolant in the flow path based on a predetermined condition.
